(19) United States
(12) Patent Application Publication
(10) Pub. No.: US 2025/0130111 A1
(43) Pub. Date: Apr. 24, 2025

(54) THERMAL DETECTOR INCLUDING A DIODE THERMOMETER TRANSDUCER

(71) Applicant: COMMISSARIAT A L'ENERGIE ATOMIQUE ET AUX ENERGIES ALTERNATIVES, Paris (FR)

(72) Inventors: Adrien FOURNOL, Grenoble Cedex 09 (FR); Abdelkader ALIANE, Grenoble Cedex 09 (FR); Laurent DUSSOPT, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/919,516

(22) Filed: Oct. 18, 2024

(30) Foreign Application Priority Data
Oct. 20, 2023 (FR) 2311415

(51) Int. Cl. G01J 5/24

(52) U.S. Cl. CPC G01J 5/24

(57) ABSTRACT

A thermal detector includes a readout substrate, including a readout circuit; and an absorbent membrane suspended above the readout substrate and thermally isolated therefrom, and including a thermometer transducer electrically connected to the readout circuit. The thermometer transducer is formed by a plurality of thermometer diodes connected in parallel and the readout circuit is adapted to activate the thermometer diodes selectively. The thermometer diodes and the readout circuit are configured so as to have at least the following two electrical configurations: a first configuration where a total electrical current I_{d} circulating in the thermometer transducer has a first value I_{d,1}; and a second configuration where the total electrical current I_{d} has a second value I_{d,2} different from I_{d,1}.

### TECHNICAL FIELD

The field of the invention is that of thermal detectors of electromagnetic radiation, example terahertz or infrared, including a membrane suspended above a readout substrate where a thermometer transducer formed by at least one diode is located.

### PRIOR ART

Thermal detectors of electromagnetic radiation, for example terahertz or infrared, can include an absorbent membrane suspended above a readout substrate and thermally isolated from the latter. The absorbent membrane includes an absorber of the electromagnetic radiation to be detected, and a thermometer transducer thermally connected thereto, an electrical property of which varies as a function of the heating thereof. Such a thermometer transducer may be a thermistor (for example a vanadium or titanium oxide, or even amorphous silicon), a diode (pn or pin junction), or even a metal oxide semiconductor field effect transistor (MOSFET).

A thermometer diode has the advantage of being able to have low thermal resolution ΔTₘᵢₙ compared with the other types of thermometer transducer, which confers on the thermal detector high-sensitivity in terms of minimum detectable power (MDP). However, the thermal resolution ΔTₘᵢₙ of the thermometer diode depends in particular on its I_{d}(V_{d}) biasing point. Moreover, the electric current I_{d} passing through the thermometer diode leads to a dissipation of heat by Joule effect, which generates auto-heating of the absorbent membrane. This auto-heating improves the sensitivity of the thermal detector but degrades its speed in terms of effective thermal response time τ_{th,eff}. Thus it appears that it is not possible to optimise one of these performance parameters (sensitivity and speed) without degrading the second.

Moreover, when a thermal detector is manufactured, the thermal diode is normally sized so as to obtain low thermal resolution ΔTₘᵢₙ and making a compromise to obtain sufficient sensitivity and speed (or favouring sensitivity or speed). When the thermal detector operates, it is not possible to adjust the performances thereof in terms of sensitivity and speed to adapt to the requirements, except by modifying the biasing voltage V_{d} of the thermometer diode, but this then leads to degradation of its thermal resolution ΔTₘᵢₙ and therefore of the sensitivity of the thermal detector.

### DESCRIPTION OF THE INVENTION

The objective of the invention is to at least partly remedy the drawbacks of the prior art, and more particularly to propose a thermal detector of electromagnetic radiation, for example terahertz or infrared radiation, that has improved performances, in particular that makes it possible to adjust the performances in a controlled manner, to thus favour the sensitivity or the speed of the thermal detector without degrading the thermal resolution of the thermometer transducer.

For this purpose, the object of the invention is a thermal detector of electromagnetic radiation including: a readout substrate, including a readout circuit; and an absorbent membrane suspended above the readout substrate and thermally isolated therefrom, and including a thermometer transducer electrically connected to the readout circuit and voltage-biased by the latter at a value V_{d}. The thermometer transducer is thermally coupled to the absorbent membrane.

According to the invention: the thermometer transducer is formed by a plurality of thermometer diodes connected in parallel and thermally coupled to each other; the readout circuit is adapted to activate the thermometer diodes selectively; and the thermometer diodes and the readout circuit are configured so as to have at least the following two electrical configurations (depending on whether all or some of the diodes are activated): a first configuration where a total electrical current I_{d} circulating in the thermometer transducer biased at the voltage V_{d} has a first value I_{d,1}; and a second configuration where the total electrical current I_{d} has a second value I_{d,2} different from I_{d,1}.

Certain preferred but non-limitative aspects of this thermal detector are as follows:

The thermometer diodes can be lateral diodes each having two doped lateral regions and a central region located, in a plane parallel to the principal plane of the absorbent membrane, between the two doped lateral regions. They can have a width different from one diode to another.

The thermometer diodes can be produced from the same crystalline semiconductor material.

The thermometer diodes can be mounted symmetrically, and can each have an identical width or not from one thermometer diode to another.

The thermometer diodes can be mounted antisymmetrically, and can each have a different width from one thermometer diode to another.

The adsorbent membrane can be suspended by thermal-insulation arms extending as far as anchoring pillars, and conductive biasing tracks can extend from the anchoring pillars passing through the thermal-insulation arms to come into electrical contact with the thermometer diodes.

One and the same conductive biasing track can be in electrical contact with an anode or with a cathode of at least two thermometer diodes connected in symmetrical mounting.

One and the same conductive biasing track can be in electrical contact with an anode or with a cathode of at least two thermometer diodes connected in antisymmetrical mounting.

The readout circuit can include at least one switch or at least one two-way switch connected to the thermometer diodes to activate the thermometer diodes selectively.

The thermal detector is preferably adapted to detect terahertz radiation or infrared radiation.

### BRIEF DESCRIPTION OF THE DRAWINGS

Other aspects, aims, advantages and features of the invention will become more apparent upon reading the following detailed description of preferred embodiments thereof, given as a non-limiting example, and made with reference to the appended drawings, wherein:

FIG. 1A is a schematic partial view in cross section of a thermal detector according to one embodiment, here in the case of a thermal detector of terahertz radiation;

FIG. 1B is a schematic partial view, in plan view, of the thermal detector illustrated on FIG. 1A;

FIG. 1C illustrates the equivalent electrical circuit of the thermometer diodes and of the readout circuit of the thermal detector illustrated on FIG. 1B;

FIG. 2A is a schematic partial view, in plan view, of a thermal detector according to a variant embodiment;

FIG. 2B illustrates the equivalent electrical circuit of the thermometer diodes and of the readout circuit of the thermal detector illustrated on FIG. 2A;

FIG. 3A is a schematic partial view, in plan view, of a thermal detector according to another variant embodiment;

FIG. 3B illustrates the equivalent electrical circuit of the thermometer diodes and of the readout circuit of the thermal detector illustrated on FIG. 3A;

FIG. 4A is a schematic partial view, in plan view, of a thermal detector according to another variant embodiment;

FIG. 4B illustrates an example of change in the auto-heating gain g_{AE} as a function of the total width of the biased thermometer diodes, in the case of the thermal detector in FIG. 4A.

### DETAILED DESCRIPTION OF PARTICULAR EMBODIMENTS

In the figures and in the remainder of the description, the same references represent identical or similar elements. In addition, the various elements are not shown to scale so as to promote clarity of the figures. Moreover, the different embodiments and variants are not mutually exclusive and can be combined together. Unless indicated otherwise, the terms “substantially”, “about”, “of the order of” mean within a 10% margin, and preferably within a 5% margin. Moreover, the terms “included between . . . and . . . ” and the like mean that the bounds are included, unless stated otherwise.

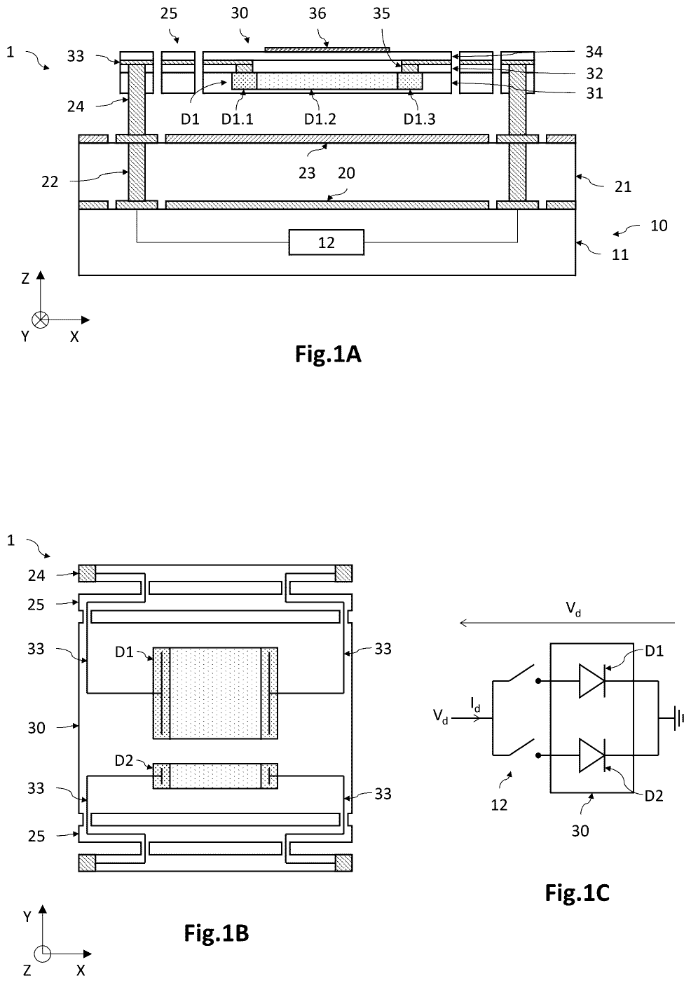

FIGS. 1A and 1B are schematic partial views of a thermal detector 1 according to one embodiment, in cross section (FIG. 1A) and in plan view (FIG. 1B). FIG. 1C illustrates an equivalent electrical circuit of the thermometer diodes D1, D2 and of the readout circuit 12.

In general terms, the thermal detector 1 according to the invention is adapted to absorb electromagnetic radiation, for example in the terahertz or infrared range. The thermal detector 1 can thus be particularly adapted to detect terahertz radiation a centre wavelength λ_{c} of which lies in a predefined spectral range from approximately 0.1 mm to 1 mm (spectral range lying between approximately 0.3 and 3 THz), or even to detect infrared radiation for example in the LWIR (Long Wavelength Infrared) range the wavelength of which is between approximately 8 μm and 14 μm.

In this example, the thermal detector 1 is adapted to detect terahertz radiation. It can belong to a matrix of identical thermal detectors arranged mutually at a pitch of the order for example of 50 μm. Only one of the detection pixels of the matrix of thermal detectors is shown here. Moreover, the thermal detector 1 includes an absorbent membrane 30 suspended above a readout substrate 10 and thermally isolated therefrom. The absorbent membrane 30 includes a thermometer transducer formed by a plurality of thermometer diodes connected in parallel by the readout circuit, here the diodes D1 and D2. The configuration of the absorbent membrane 30 and of the thermometer diodes D1, D2 is described here by way of illustration: as explained in later, other configurations are possible.

A three-dimensional direct reference frame XYZ is defined here where the plane XY is substantially parallel to the plane of the readout substrate 10, the axis Z being oriented in a direction substantially orthogonal to the plane of the readout substrate 10 in the direction of the absorbent membrane 30. The terms “lower” and “upper” should be understood as relating to an increase in position on moving away from the readout substrate 10 in the direction +Z.

The thermal detector 1 includes a functionalised substrate 10, referred to as a readout substrate, produced in this example from silicon, including a readout circuit 12 for controlling and reading the thermal detectors. The readout circuit 12 here is in the form of a CMOS integrated circuit located in a support substrate 11. It includes conductive-line portions (not shown), for example metal, separated from one another by an electrically insulating material, for example a mineral material based on silicon such as a silicon oxide SiOₓ, a silicon nitride SiNₓ, or alloys thereof. It can also include active electronic elements (not shown), for example diodes or transistors, or passive electronic elements, for example capacitors, resistors, etc, connected by electrical interconnections firstly to the absorbent membrane 30 and secondly to a connection pad (not shown), the latter being intended to connect the thermal detector 1 to an external electronic device.

As detailed hereinafter, the readout circuit 12 is adapted to voltage-bias the thermometer transducer at a predefined value V_{d}, which can be selected to optimise the thermal resolution ΔTₘᵢₙ. In addition, the thermometer transducer is formed by a plurality of thermometer diodes connected in parallel (here the diodes D1 and D2), the readout circuit 12 is adapted to activate the thermometer diodes (i.e. to bias them in the on direction) independently of one another, i.e. selectively. For this purpose, the readout circuit includes one or more switches or two-way switches. Thus a non-activated diode is either not biased or biased in the off direction: in both cases, an electric current does not, or almost does not, pass through it.

The thermal detector 1 preferably includes a reflector 20, produced from at least one material reflective with respect to the terahertz radiation to be detected. It rests here on the surface of an insulating layer of the readout substrate 10. In a variant, it can be formed by a portion of the conductive line of the last electrical interconnection level of the CMOS integrated circuit, and therefore be located in the readout substrate 10.

The readout substrate 10 and the reflector 20 are here covered by an insulating layer 21 produced from a dielectric material, such as a silicon oxide. This insulating layer 21 makes it possible in particular to adapt the height of a cavity formed between the reflector 20 and a high-impedance surface 23. Its thickness can be adjusted to optimise the absorption of the radiation to be detected by an absorber 36 located on the absorbent membrane 30. It can thus be substantially equal to λ/4n, where λ is a reference wavelength of the terahertz radiation to be detected and n is the refractive index of the insulating layer 21.

The thermal detector 1 includes here connection pillars 22, produced from an electrically conductive material, which pass through the insulating layer 21 and provide the electrical connection between anchoring pillars 24 and the readout circuit 12.

The thermal detector 1 includes here a high-impedance surface (HIS) 23, adapted to reflect, without phase shift, the terahertz radiation to be detected. It is located under the absorbent membrane 30 and at a distance therefrom along the Z axis, and is coupled to an absorber 36 located on the absorbent membrane 30, here a resistive dipole. In this example, the high-impedance surface 23 rests on the readout substrate 10, and here on the insulating layer 21. It is spaced apart from the reflector 20 and from the absorber 36 by a distance making it possible to optimise the absorption of the terahertz radiation by the absorber 36. The high-impedance surface 23 is produced from a material selected from aluminium, copper and gold, among others, and has a thickness of between for example 50 nm and 500 nm, preferably of the order of 300 nm.

The thermal detector 1 includes a thermometric membrane 30 suspended above the readout substrate 10 and here from the high-impedance surface 23 by anchoring pillars 24, and isolated therefrom by thermal-insulation arms 25. The anchoring pillars 24 and the thermal-insulation arms 25 also provide the electrical connection of the thermometer transducer to the readout circuit 12 (here via the connection pillars 22). The anchoring pillars 24 are produced from at least one electrically conductive material and are electrically connected to the underlying connection pillars 22 (and extend here vertically to the latter). The thermal-insulation arms 25 include a layer 33 produced from at least one electrically conductive material, which extends anchoring pillars 24 as far as the diodes D1, D2 while forming biasing conductive tracks for voltage-biasing the thermometer diodes D1, D2 at a predefined value V_{d}.

The absorbent membrane 30 therefore includes a thermometric transducer formed here by a plurality of diodes D1, D2, . . . , referred to as thermometer diodes. The thermometer diodes D1, D2 rest on an insulating lower layer 31, produced for example from amorphous silicon or from another electrically insulating material, and is in contact with biasing pads 35, which are in electrical contact with the biasing conductive tracks 33.

The thermometer transducer includes at least two thermometer diodes. In this example, two thermometer diodes D1, D2 are shown, but more diodes can be present, for example three or four diodes, depending in particular on the configuration of the biasing conductive tracks 33.

The thermometer diodes D1, D2 are lateral diodes, in that the charge carriers are injected into the semiconductor junction horizontally (substantially parallel to the plane XY) rather than vertically (along the Z axis). They are formed by a layer made from a crystalline semiconductor material, for example from silicon, formed by two p-doped lateral regions (anode D1.1 for the diodes D1) and n-doped (cathode D1.3), between which a not intentionally doped or lightly doped central region (D1.2) is located. The lateral and central regions are aligned in the plane XY along a longitudinal axis (here parallel to the X axis). The two lateral regions are preferably overdoped to ensure good ohmic contact with the biasing pads.

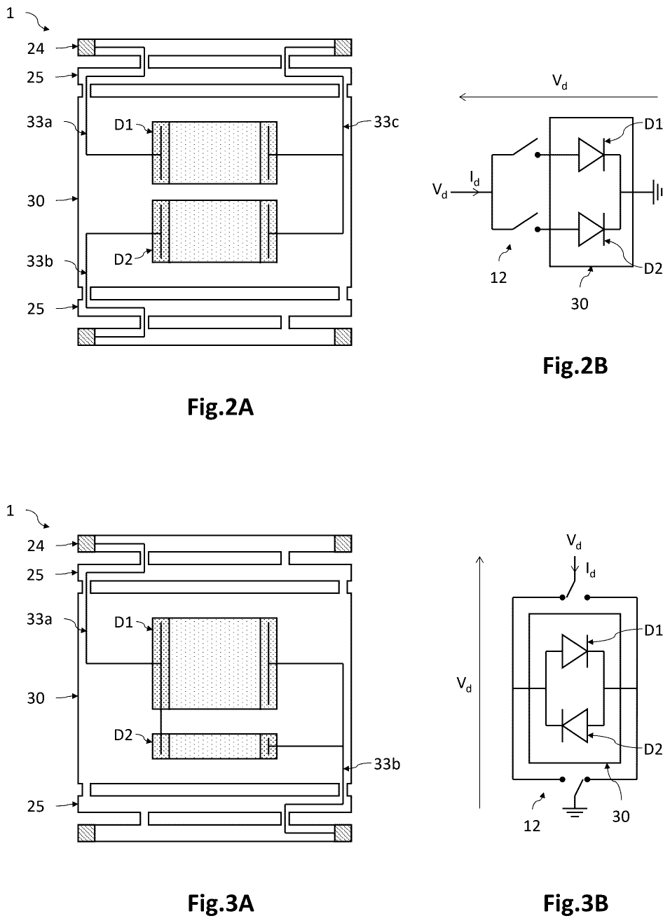

The semiconductor layer of each thermometer diode D₍ᵢ₎ has a length L, a width W₍ᵢ₎ and a thickness e. Preferably, the length L is identical for all the thermometer diodes. Preferably also, the thickness e is identical for all the thermometer diodes. Preferably, the level and the type of doping of the lateral and central regions are identical for all the thermometer diodes. Finally, the width W₍ᵢ₎ of the thermometer diodes can be identical or not, depending on the type of electrical connection. Preferably, the width of a thermometer diode is constant along the longitudinal axis thereof. The width of a thermometer diode is defined as being the dimension of the semiconductor layer in the plane XY and along an axis orthogonal to the longitudinal axis. In the case of a symmetrical electrical connection such as those in FIG. 1C and 2B, the width of the thermometer diodes can be identical or different from one diode to another. On the other hand, in the case of an antisymmetrical electrical connection such as those in FIG. 3B (a connection also referred to as head to tail), then the width W₍ᵢ₎ of the thermometer diodes is different from one diode to another. It should be noted that, in a symmetrical connection, the thermometer diodes are oriented in the same way with respect to the voltage applied, whereas in an antisymmetrical or head to tail connection the diodes have an opposite orientation to each other with respect to the voltage applied.

The thermometer diodes D1, D2 are connected, parallel to each other, to the readout circuit 12, which is adapted to voltage-bias them by applying a predefined value V_{d}. In addition, the readout circuit 12 is adapted to activate the thermometer diodes D1, D2 (i.e. to bias them in the on direction) independently of one another. For this purpose, the readout circuit 12 includes at least one switch, here two switches. In this example, the readout circuit 12 can, by actuating the switches, bias one or other of the thermometer diodes, or all the thermometer diodes at the same time.

The thermometer diodes D1, D2 are covered by an insulating intermediate layer 32. The conductive biasing tracks 33 extend here over the insulating intermediate layer 32, and come into contact with the biasing pads 35. In this example, two conductive tracks 33 are in electrical contact with the anode D1.1 and the cathode D1.3 of the thermometer diode D1, and two other conductive tracks 33 are in electrical contact with the anode and the cathode of the thermometer diode D2. Here, each of the four thermal-insulation arms 25 here has a biasing conductive track 33 running through it.

An insulating layer 34 covers the conductive tracks 33 and the biasing pads 35. The absorber 36 is formed by an antenna with a resistive load adapted to its impedance (resistive dipole), which rests here on the insulating upper layer 34, and can be covered by a protective layer (not shown). The absorber 36 is adapted to dissipate heat by Joule effect when it has an electric current running through it. It is arranged in the absorbent membrane 30 so as to be in thermal contact with the thermometer diodes D1, D2 (thermal coupling), so that the heat dissipated by Joule effect leads to an increase in the temperature of the thermometer diodes D1, D2. It will be understood that the thermometer diodes of the thermometer transducer are thermally coupled to each other: they therefore have the same temperature, whether one or other or both of the thermometer diodes are activated. The absorber 36 is here spaced apart and electrically insulated from the thermometer diodes D1, D2 by the insulating upper layer 34, which can be produced for example from a silicon oxide or nitride and can have a thickness for example of the order of approximately 10 nm. However, other arrangements of the resistive load with respect to the thermometer diodes are possible. It can thus be located under the thermometer diodes.

In general terms, the thermometer diodes D1, D2 and the readout circuit 12 are configured so as to have at least the following two electrical configurations (depending on whether all or some of the thermometer diodes are activated): a first configuration where the total electrical current I_{d} circulating in the thermometer transducer (i.e. in the thermometer diodes biased in the on direction) has a first value I_{d,1}; and a second configuration where the total electrical current I_{d} has a second value I_{d,2} different from I_{d,1}. Thus, whatever the electrical configuration, the thermometer diodes have the same temperature, being thermally coupled to each other.

In this example, the thermometer diodes D1, D2 are connected symmetrically, and the readout circuit 12 can bias one or other or both of the thermometer diodes D1, D2 selectively. The thermometer diode D1 has a width W₁ and the thermometer diode D2 has a width W₂ less than W₁. The voltage V_{d} is applied to the thermometer transducer. Three electrical configurations are then possible: a first configuration where the two thermometer diodes are activated at the same time: the total electric current Id circulating in the thermometer transducer then has a maximum value I_{d,max}. It is possible, in another configuration, to activate only the single diode D1, leading to a total electrical current I_{d} having a value I_{d,1} less than I_{d,max}; and, in a last configuration, to activate only the single diode D2, leading to a total electric current I_{d} having a value I_{d,2} less than I_{d,max} and less than I_{d,1}: I_{d,2}<I_{d,1}<I_{d,max}.

It should be noted that, in these three configurations of the electrical connection, the density of current passing through the thermometer transducer has the same value J_{d}, so that the thermal resolution ΔTₘᵢₙ of the thermometer transducer remains constant. Thus the thermal detector 1 has performances in terms of sensitivity and speed that can be adjusted having regard to the applications sought, without degrading the thermal resolution ΔTₘᵢₙ of the thermometer transducer.

Thus, in the case of the detection of a low incident flow, the sensitivity of the thermal detector 1 will be favoured over the speed thereof: it will therefore be sought to increase the auto-heating g_{AE} of the absorbent membrane 30, and therefore the value of the total electric current I_{d}: the readout circuit 12 will bias the single diode D1 or preferably the two diodes D1 and D2 at the same time. On the other hand, in the case of the detection of a moving scene, the speed of the thermal detector 1 will be favoured: it will therefore be sought to limit the auto-heating g_{AE} of the absorbent membrane 30, and therefore the value of the total electric current I_{d}: the readout circuit 12 will preferably bias the single diode D2. A compromise may however be sought between the sensitivity and the speed of the thermal detector 1: thus the readout circuit will be able to bias the diode D1 alone. It is therefore clear that the thermal detector 1 has great versatility of its performances in terms of sensitivity and speed, through controlling the activation of the thermometer diodes independently of each other, without this resulting in a degradation of the thermal resolution ΔTₘᵢₙ of the thermometer transducer.

FIG. 2A is a schematic partial view, in cross section, of a thermal detector 1 according to a variant embodiment. FIG. 2B illustrates partially the equivalent electrical circuit of the thermometer diodes D1, D2 and of the readout circuit 12.

The thermal detector 1 is distinguished from the one in FIG. 1B mainly in that the thermometer diodes D1, D2 have identical widths, and in that one and the same biasing conductive track 33c makes it possible to take the cathodes of the thermometer diodes D1, D2 to the same electrical potential.

Thus the thermometer transducer includes a diode D1 of width W1 and a diode D2 of width W2 equal to W1 (however, the widths W1 and W2 may of course be different).

Moreover one and the same biasing conductive track 33c extends over one of the thermal-insulation arms and comes into electrical contact with the cathode of the diode D1 and that of the diode D2. On the other hand, another biasing conductive track 33a comes into electrical contact with the anode of the diode D1, and another biasing conductive track 33b is in electrical contact with the anode of the diode D2. Thus the readout circuit 12, which includes here switches connected in series, one with the diode D1 and the other with a diode D2, makes it possible to selectively activate the diode D1 alone, the diode D2 alone, or the two diodes D1 and D2.

Other electrical connections are obviously possible, such as providing one and the same biasing conductive track 33c for the anodes of the diodes D1 and D2, and two other distinct biasing conductive tracks 33a, 33b for the cathodes.

The thermal detector 1 according to this variant embodiment has better thermal insulation of the absorbent membrane 30, since one of the thermal-insulation arms 25 does not include a biasing conductive track 33, which improves its performances of the thermal detector 1 in terms of thermal insulation and therefore sensitivity.

FIG. 3A is a schematic partial view, in cross section, of a thermal detector 1 according to another variant embodiment. FIG. 3B illustrates partially the equivalent electrical circuit of the thermometer diodes D1, D2 and of the readout circuit 12.

The thermal detector 1 is distinguished from the one in FIG. 1B mainly in that the thermometer diodes D1, D2 are connected head to tail (still in parallel), and in that two single biasing conductive tracks 33a, 33b make it possible to apply a potential difference to the thermometer diodes.

The thermometer transducer is therefore formed by two diodes D1 and D2 connected head to tail (antisymmetrical connection), in that here the cathode of D1 and the anode of D2 are connected to one and the same node of the electrical circuit and are therefore taken to the same electrical potential, and in that the anode of D1 and the cathode of D2 are connected to another same node of the electrical circuit.

The thermometer diodes D1 and D2 being mounted head to tail, they have different widths. In this example, the width W1 is greater than the width W2.

Moreover, one and the same biasing conductive track 33a extends in a thermal-insulation arm 25 and comes into electrical contact with the anode of the diode D1 and the cathode of the diode D2. Another biasing conductive track 33b extends in another thermal-insulation arm and comes into electrical contact with the cathode of D1 and the anode of the diode D2. Other electrical connections are obviously possible. Two two-way switches make it possible to apply the biasing V_{d} to the diodes D1 and D2 in one direction or the other of the electrical connection.

In operation, a biasing voltage V_{d} is applied to the diodes connected in parallel. Depending on the sign of the voltage V_{d}, one of the diodes is in the on state whereas the other is in the off state. Thus it is possible to have an electrical configuration where the diode D1 alone is in the on state, so that the total electric current I_{d} has a value I_{d,1}, and another electrical configuration whether diode D2 alone is in the on state, so that the total electric current I_{d} has a value I_{d,2}, different from I_{d,1} because of the difference between the widths W₁ and W₂.

The thermal detector 1 according to this variant embodiment has even higher thermal insulation of the absorbent membrane, since only two thermal-insulation arms out of the four thermal-insulation arms each have a biasing conductive track 33, which improves its performances of the thermal detector 1 in terms of thermal insulation and therefore sensitivity.

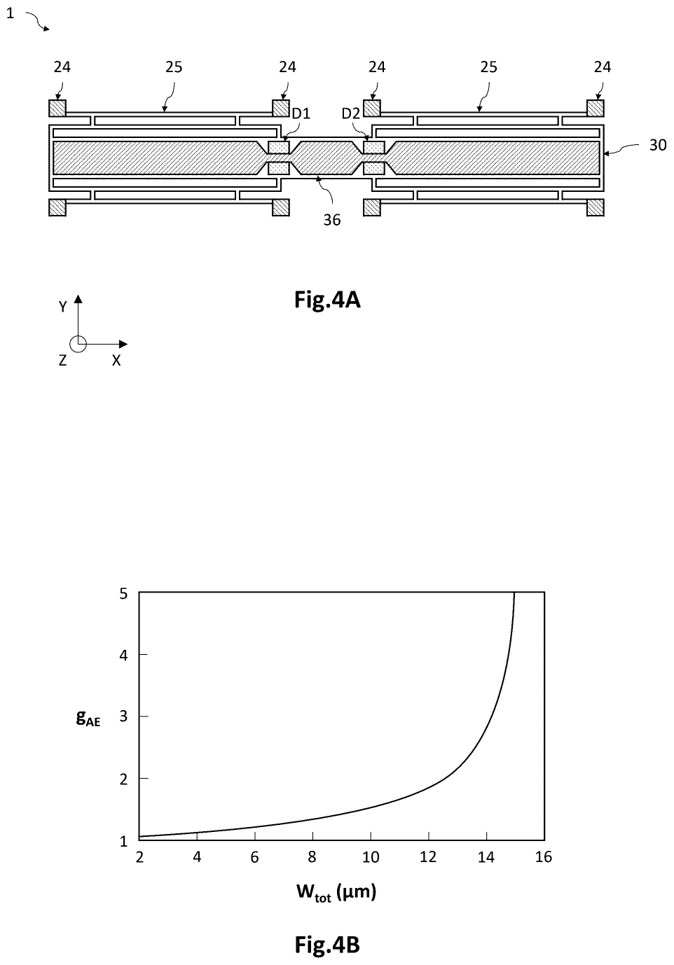

FIG. 4A is a schematic partial plan view of a thermal detector 1 according to another variant embodiment. FIG. 4B illustrates an example of change in the auto-heating gain g_{AE} of the absorbent membrane 30 as a function of the total width Wₜₒₜ of the thermometer diodes activated.

The thermal detector 1 is adapted here to absorb in the sub-terahertz band, for example between 100 GHz et 1 THz. The operating temperature can be approximately 80K so as to minimise the thermal resolution of the thermometer diodes.

The insulating layer 21 located between the reflector 21 and the high-impedance surface 23 has a thickness of approximately 11 μm (cf. FIG. 1A). The high-impedance surface 23 is produced by a layer of aluminium. The absorbent membrane is based apart from the high-impedance surface 23 by approximately 2.5 μm.

The absorber 36 (metal dipole) is produced here from niobium. The coupling between the high-impedance surface 23 and the absorber 36 provides the absorption of the terahertz radiation. In this example where it is wished for the absorption spectrum to be centred on the 425 GHz frequency, the absorber 36 has a dimension of 6 μm wide and 265 μm long. With these dimensions, integration of a plurality of thermometer diodes D1 and D2 is facilitated. Moreover, the biasing conductive tracks 33 are here produced from TiN, and the insulating layers 31, 32, 34 are produced from amorphous silicon.

The absorbent membrane 30 is here a rectangular shape with a high length to width shape ratio. Four thermal-insulation arms 25 hold the absorbent membrane 30. Two thermometer diodes D1, D2 are located in a central part of the absorbent membrane 30. The absorber 36 has, facing the thermometer diodes D1, D2, a width less than the 6 μm indicated previously.

The thermometer diodes D1, D2 are produced from crystalline silicon with a thickness of between for example 20 nm and 300 nm, for example equal to approximately 50 nm. The n+ doped lateral region is doped with phosphorus, and the p+ doped lateral region is doped with boron. The doping level is here greater than 10¹⁹ cm⁻³ so as to ensure good ohmic contact. The doping level (of type n or of type p) of the central region is here between 10¹⁵ and 10¹⁸ cm⁻³, for example equal to 10¹⁷ cm⁻³. Moreover, the length of the central region is preferably between 1 and 10 μm, for example equal to 5 μm, so as to optimise the thermal resolution.

Under these conditions, the thermometer diodes D1, D2 have a thermal resolution ΔTₘᵢₙ, for a biasing voltage V_{d} of approximately 1.02 V (corresponding to a current density of 2 nA/μm), equal to approximately 0.15 mK, and a current-temperature coefficient (TCC) greater than 20%/K for a current density of approximately 2 nA/μm. The total thermal resistance Rₜₕ is here equal to 80 MK/W. It is then possible to determine the auto-heating g_{AE} of the absorbent membrane 30, for an absorbed power in the spectral band of 1 nW.

FIG. 4B illustrates an example of variation in the auto-heating g_{AE} as a function of the total width Wₜₒₜ of the thermometer diodes activated by the readout circuit. The total width corresponds to the sum of the widths of the thermometer diodes activated. It should be noted that the auto-heating g_{AE} remains close to unity for a total width Wₜₒₜ of less than approximately 7 μm. Moreover, for a total width of the biased diodes of approximately 14.2 μm, thermal runaway takes place, which is obviously to be avoided since it may lead to degradation of the materials of the absorbent membrane. This thermal runaway takes place when the sum of the absorbed power and of the power generated by Joule effect in the absorbent membrane is too great to be discharged by the thermal-insulation arms.

Thus, by adjusting the total width Wₜₒₜ by the selective activation of the thermometer diodes biased at a voltage V_{d}, it is possible to adjust the auto-heating g_{AE} to favour the sensitivity and/or the speed of the thermal detector, without degrading the thermal resolution ΔTₘᵢₙ of the thermometer diodes.

Particular embodiments have just been described. Various variants and modifications will become apparent to a person skilled in the art.

1. A thermal detector of electromagnetic radiation, comprising:
a readout substrate, including a readout circuit;
an absorbent membrane suspended above the readout substrate and thermally isolated therefrom, and including a thermometer transducer electrically connected to the readout circuit and voltage-biased by the latter at a value V_{d} and thermally coupled to the absorbent membrane;
the thermometer transducer being formed by a plurality of thermometer diodes connected in parallel and thermally coupled to each other;
the readout circuit being adapted to activate the thermometer diodes selectively;
the thermometer diodes and the readout circuit being configured so as to have at least the following two electrical configurations: a first configuration where a total electrical current I_{d} circulating in the thermometer transducer biased at the voltage V_{d} has a first value I_{d,1}; and a second configuration where the total electrical current I_{d} has a second value I_{d,2} different from I_{d,1}.

2. The thermal detector according to claim 1, wherein the thermometer diodes each have a different width from one thermometer diode to another.

3. The thermal detector according to claim 1, wherein the thermometer diodes are lateral diodes each having two doped lateral regions and a central region located, in a plane parallel to the principal plane of the absorbent membrane, between the two doped lateral regions.

4. The thermal detector according to claim 3, wherein the thermometer diodes are produced from the same crystalline semiconductor material.

5. The thermal detector according to claim 1, wherein the adsorbent membrane is kept suspended by thermal-insulation arms extending as far as anchoring pillars, and wherein conductive biasing tracks extend from the anchoring pillars passing through the thermal-insulation arms to come into electrical contact with the thermometer diodes.

6. The thermal detector according to claim 1, wherein the thermometer diodes are mounted symmetrically, and each have an identical width or not from one thermometer diode to another.

7. The thermal detector according to claim 5, wherein one and the same conductive biasing track is in electrical contact with an anode or with a cathode of at least two thermometer diodes connected in symmetrical mounting.

8. The thermal detector according to claim 1, wherein the thermometer diodes are mounted antisymmetrically, and each have a different width from one thermometer diode to another.

9. The thermal detector according to claim 5, wherein one and the same conductive biasing track is in electrical contact with an anode or with a cathode of at least two thermometer diodes connected in antisymmetrical mounting.

10. The thermal detector according to claim 1, wherein the readout circuit includes at least one switch or at least one two-way switch connected to the thermometer diodes to activate the thermometer diodes selectively.

11. The thermal detector according to claim 1, adapted to detect terahertz radiation or infrared radiation.
